(19) United States
(12) Patent Application Publication
(10) Pub. No.: US 2025/0167224 A1
(43) Pub. Date: May 22, 2025

(54) ELECTRODE COMPOSITE MATERIAL SLURRY FOR SOLID-STATE BATTERY AND PRODUCTION METHOD FOR ELECTRODE COMPOSITE MATERIAL SLURRY

(71) Applicants: TOYOTA JIDOSHA KABUSHIKI KAISHA, Toyota-shi (JP); PANASONIC HOLDINGS CORPORATION, Osaka (JP)

(72) Inventors: Yasutaka TSUTSUI, Osaka-shi (JP); Masahiro IWASAKI, Nagoya-shi (JP)

(73) Assignees: TOYOTA JIDOSHA KABUSHIKI KAISHA, Toyota-shi (JP); PANASONIC HOLDINGS CORPORATION, Osaka (JP)

(21) Appl. No.: 18/953,387

(22) Filed: Nov. 20, 2024

(30) Foreign Application Priority Data
Nov. 20, 2023 (JP) 2023-196480
Nov. 8, 2024 (JP) 2024-196168

(51) Int. Cl. H01M 4/485; H01M 4/02; H01M 4/583; H01M 4/62

(52) U.S. Cl. CPC H01M 4/485; H01M 4/583; H01M 4/622; H01M 2004/021; H01M 2004/027

(57) ABSTRACT

An electrode composite material slurry contains an electrode active material, a solid electrolyte, and a dispersion medium, and the particle diameter of the electrode composite material slurry measured by a fineness gauge method is 60 μm or less. A production method for the electrode composite material slurry includes (i) preparing the electrode composite material slurry by applying a dispersion energy of 1.0×10⁶ J/L or more to a preliminary electrode composite material slurry and stirring the preliminary electrode composite material slurry and/or (ii) preparing the electrode composite material slurry by stirring the preliminary electrode composite material slurry until the particle diameter that is measured by the fineness gauge method becomes 0.75 times or less the particle diameter that is measured by the fineness gauge method when a dispersion energy of 5.0×10⁵ J/L is applied to the preliminary electrode composite material slurry and stirring is performed.

### CROSS-REFERENCE TO RELATED APPLICATION

This application claims priority to Japanese Patent Application No. 2023-196480 filed on Nov. 20, 2023, and to Japanese Patent Application No. 2024-196168 filed on Nov. 8, 2024. The disclosure of each of the above-identified applications, including the specification, drawings, and claims, is incorporated by reference herein in its entirety.

### BACKGROUND

### 1. Technical Field

The present disclosure relates to an electrode composite material slurry for a solid-state battery and a production method for the electrode composite material slurry.

### 2. Description of Related Art

Generally, an electrode active material layer or solid electrolyte layer that is used in a solid-state battery is formed by coating the surface of a base material with an electrode composite material slurry or solid electrolyte composite material slurry that contains an electrode active material, a solid electrolyte, and a dispersion medium, performing drying, and as necessary, performing pressing. There is known a production method for an all-solid-state battery that uses a binder composition described below and a solid electrolyte composite material slurry containing the binder composition.

For example, Japanese Unexamined Patent Application Publication No. 2021-195374 (JP 2021-195374 A) discloses a binder composition containing a dispersion medium and binder particles, in which the binder particles are dispersed in the dispersion medium, the binder particles contains a polymer material, the polymer material contains a constituent unit deriving from vinylidene fluoride, the binder particles have a number-basis particle diameter distribution, the particle diameter distribution satisfies conditions in the following Expressions (1) to (3):

$$0.19 \leq X \leq 0.26 \qquad ( 1 )$$

$$0.69 \leq Y \leq 0.76 \qquad ( 2 )$$

$$0 \leq Z \leq 0 \text{.05} , \qquad ( 3 )$$

where X in Expression (1) indicates the frequency of particles having particle diameters of 40 μm or less, Y in Expression (2) indicates the frequency of particles having particle diameters of more than 40 μm and 110 μm or less, and Z in Expression (3) indicates the frequency of particles having particle diameters of more than 110 μm and 250 μm or less. It is described that the biner composition in JP 2021-195374 A makes it hard for an aggregate to be formed in a slurry composition containing a sulfide solid electrolyte. Furthermore, JP 2021-195374 A discloses a production method for an all-solid-state battery that includes: preparing a slurry composition by mixing the binder composition and a sulfide solid electrolyte; cracking an aggregate contained in the slurry composition; forming a separator by applying the slurry composition on the surface of a base material and performing drying, after the cracking of the aggregate; and producing an all-solid-state battery including the separator. The production method for the all-solid-state battery in JP 2021-195374 A reduces the aggregate, and thereby, the variation in the thickness of the separator becomes small, so that the reduction in the discharge resistance of the all-solid-state battery is expected.

### SUMMARY

In the production method for the all-solid-state battery in JP 2021-195374 A, as described above, the aggregate is reduced in the slurry for forming the solid electrolyte layer, and thereby, the variation in the thickness of the separator (solid electrolyte layer) that is obtained becomes small, so that the reduction in the discharge resistance of the all-solid-state battery is expected.

However, the inventors have found that a slight degree of aggregation increases the battery resistance even when the aggregation that is observed as the variation in the thickness of the electrode active material layer that is obtained does not occur, in the case where the electrode active material layer is obtained using the electrode composite material slurry.

Hence, the present disclosure has an object to provide an electrode composite material slurry for a solid-state battery that makes it possible to obtain an electrode active material layer that reduces the battery resistance, and a production method for the electrode composite material slurry.

The present disclosure achieves the above object by the following means.

<Aspect 1> An electrode composite material slurry for a solid-state battery, wherein:
the electrode composite material slurry contains an electrode active material, a solid electrolyte, and a dispersion medium; and
a particle diameter of the electrode composite material slurry that is measured by a fineness gauge method is 60 μm or less.

<Aspect 2> The electrode composite material slurry according to aspect 1, wherein the electrode composite material slurry contains a rubber binder.

<Aspect 3> The electrode composite material slurry according to aspect 1 or 2, wherein the electrode composite material slurry contains a negative electrode active material.

<Aspect 4> A production method for the electrode composite material slurry according to any one of aspects 1 to 3, the production method including:
providing a preliminary electrode composite material slurry that contains an electrode active material, a solid electrolyte, and a dispersion medium; and
(i) preparing the electrode composite material slurry by applying a dispersion energy of 1.0×10⁶ J/L or more to the preliminary electrode composite material slurry and stirring the preliminary electrode composite material slurry and/or (ii) preparing the electrode composite material slurry by stirring the preliminary electrode composite material slurry until the particle diameter that is measured by the fineness gauge method becomes 0.75 times or less the particle diameter that is measured by the fineness gauge method when a dispersion energy of 5.0×10⁵ J/L is applied to the preliminary electrode composite material slurry and the preliminary electrode composite material slurry is stirred.

<Aspect 5> An electrode active material layer for a solid battery, including:
a maximum particle diameter of an electrode active material and a solid electrolyte measured from an SEM image of a cross section of the electrode active material layer is 60 μm or less.

With the electrode composite material slurry and the production method for the electrode composite material slurry in the present disclosure, it is possible to obtain an electrode active material layer that reduces the battery resistance.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a graph showing the relation between dispersion energy and the particle diameter of a negative electrode composite material slurry about Examples 1 and 2 and Comparative Example 2.

### DETAILED DESCRIPTION OF EMBODIMENTS

An embodiment of the present disclosure will be described below in detail. The present disclosure is not limited to the embodiment described below, and can be carried out while being variously modified within the scope of the spirit of the present disclosure.

In the present disclosure, a “composite material” means a composition that can compose an electrode active material layer or a solid electrolyte layer just as it is or by further containing another component. Further, in the present disclosure, a “composite material slurry” means a slurry that contains a dispersion medium in addition to the “composite material” and thereby can form the electrode active material layer or the solid electrolyte layer by application and drying.

In the present disclosure, a “solid-state battery” means a battery in which at least a solid electrolyte is used as an electrolyte, and accordingly, in the solid-state battery, a combination of a solid electrolyte and a liquid electrolyte may be used as the electrolyte. Further, the solid-state battery may be an all-solid-state battery, that is, a battery in which only a solid electrolyte is used as the electrolyte.

### Electrode Composite Material Slurry for Solid-State Battery

In an electrode composite material slurry for a solid-state battery in the present disclosure,
the electrode composite material slurry contains an electrode active material, a solid electrolyte, and a dispersion medium, and
the particle diameter of the electrode composite material slurry that is measured by a fineness gauge method is 60 μm or less.

With the electrode composite material slurry in the present disclosure, it is possible to obtain an electrode active material layer that reduces the battery resistance.

Generally, the particle diameter that is measured by the fineness gauge method is known as an index for obtaining a coating film having a uniform external appearance in a slurry containing pigment or the like. The inventors have found that the particle diameter of the electrode composite material slurry that is measured by the fineness gauge method is related to not only the uniformity of the coating film but also the battery resistance.

Specifically, for example, when the particle diameter of the electrode composite material slurry that is measured by the fineness gauge method is 60 μm, an electrode active material layer having a uniform external appearance can be obtained, and the resistance of a solid-state battery including the electrode active material layer formed from the electrode composite material slurry is sufficiently low. Further, when the particle diameter of the electrode composite material slurry that is measured by the fineness gauge method is 80 μm, the electrode active material layer having a uniform external appearance can be obtained. However, the resistance of a solid-state battery including the electrode active material layer formed from the electrode composite material slurry is high, and it has become clear that a difference in performance is made by the difference in the particle diameter that is measured by the fineness gauge method, despite the electrode composite material slurry having the same composition. Accordingly, when the particle diameter of the electrode composite material slurry that is measured by the fineness gauge method is 60 μm or less, it is possible to obtain an electrode active material layer that has a uniform external appearance and that reduces the battery resistance.

### Constitution of Electrode Composite Material Slurry for Solid-State Battery

The electrode composite material slurry for the solid-state battery in the present disclosure contains an electrode active material, a solid electrolyte, and a dispersion medium. Furthermore, the electrode composite material slurry may optionally contain a binder and a conduction aid. In addition, the electrode composite material slurry may contain various additive agents.

Respective contents of the electrode active material, solid electrolyte, dispersion medium and others in the electrode composite material slurry may be appropriately decided depending on an intended slurry characteristic and battery performance. For example, when the whole solid content of the electrode composite material slurry is 100 parts by mass, the content of the electrode active material may be 40 parts by mass or more, 50 parts by mass or more, or 60 parts by mass or more, and may be 99 parts by mass or less, or 90 parts by mass or less. Further, for example, the solid content concentration (the whole solid content/(the whole solid content+the dispersion medium)) of the electrode composite material slurry may be 40 mass % or more, 50 mass % or more, 60 mass % or more, 70 mass % or more, or 75 mass % or more, and may be 90 mass % or less, 85 mass % or less, or 80 mass % or less.

### Electrode Active Material

The electrode active material that is contained in the electrode composite material slurry may be a positive electrode active material, or may be a negative electrode active material. Although not particularly limited, it is preferable that the electrode composite material slurry for the solid battery in the present disclosure contains the negative electrode active material.

### Negative Electrode Active Material

As the negative electrode active material, various substances in which an electric potential (charge and discharge potential) at which lithium ions are stored and released is a base potential compared to the positive electrode active material can be employed. The material of the negative electrode active material is not particularly limited, and may be a material that can store and release metal ions such as lithium ions. Examples of the material that can store and release metal ions such as lithium ions include lithium titanate (Li₄Ti₅O₂), alloy system negative electrode active materials, and carbon materials.

The alloy system negative electrode active material is not particularly limited, and examples of the alloy system negative electrode active material include a silicon alloy system negative electrode active material or a tin alloy system negative electrode active material. Examples of the silicon alloy system negative electrode active material include silicon, silicon oxide, silicon carbide, silicon nitride, and solid solutions of them. Further, the silicon alloy system negative electrode active material may contain a metal element other than silicon, and for example, may contain Fe, Co, Sb, Bi, Pb, Ni, Cu, Zn, Ge, In, Sn, Ti, or the like. Examples of the tin alloy system negative electrode active material include tin, tin oxide, tin nitride, and solid solutions of them. Further, the Sn alloy system negative electrode active material may contain a metal element other than tin, and for example, may contain Fe, Co, Sb, Bi, Pb, Ni, Cu, Zn, Ge, In, Ti, Si, or the like.

The carbon material is not particularly limited, and examples of the carbon material include hard carbon, soft carbon, and graphite.

The form of the powder of the negative electrode active material is not particularly limited, as long as a general form for the negative electrode active material of a lithium-ion battery is adopted. For example, the negative electrode active material may have a particle form. The negative electrode active material may have a primary particle, or may have a secondary particle in which a plurality of primary particles is aggregated. For example, an average particle diameter D₅₀ of the negative electrode active material as a raw material may be 1 nm or more, 5 nm or more, or 10 nm or more, and may be 50 μm or less, or m or less. The average particle diameter D₅₀ is a particle diameter (median diameter) at an integrated value of 50% in a volume-basis particle size distribution that is evaluated by a laser diffracting/scattering method.

### Positive Electrode Active Material

The material of the positive electrode active material is not particularly limited. Examples of the positive electrode active material include lithium cobalt oxide (LiCoO₂), lithium nickel oxide (LiNiO₂), lithium manganese oxide (LiMn₂O₄), lithium nickel-cobalt-manganese oxide (NCM), LiCo_{1/3}Ni_{1/3}Mn_{1/3}O₂, lithium nickel-cobalt-aluminum oxide (NCA; LiNiₓCo_{y}Al_{z}O₂), and a different-element substitution Li—Mn spinel having a composition expressed as Li₁₊ₓMn_{2-x-y}M_{y}O₄ (M is one or more kinds of metal elements selected from Al, Mg, Co, Fe, Ni, and Zn), but are not limited to them.

Although not particularly limited, the positive electrode active material may include a covering layer. The covering layer is a layer containing a substance that has a lithium-ion conductibility, that has a low reactivity with the positive electrode active material or the solid electrolyte, and that does not flow and can maintain the form of the covering layer even when the substance makes contact with the active material or the solid electrolyte. Specific examples of the material that composes the covering layer include LiNbO₃, Li₄Ti₅O₁₂, and Li₃PO₄, but are not limited to them.

The form of the powder of the positive electrode active material is not particularly limited, as long as a general form for the positive electrode active material of a lithium-ion battery is adopted. For example, the positive electrode active material may have a particle form. The positive electrode active material may have a primary particle, or may have a secondary particle in which a plurality of primary particles is aggregated. For example, an average particle diameter D₅₀ of the positive electrode active material as a raw material may be 1 nm or more, 5 nm or more, or 10 nm or more, and may be 50 μm or less, or m or less. The average particle diameter D₅₀ is a particle diameter (median diameter) at an integrated value of 50% in a volume-basis particle size distribution that is evaluated by a laser diffracting/scattering method.

### Solid Electrolyte

The material of the solid electrolyte is not particularly limited, and for example, may be a sulfide solid electrolyte, an oxide solid electrolyte, a polymer electrolyte, or the like.

Examples of the sulfide solid electrolyte include a sulfide amorphous solid electrolyte, a sulfide crystalline solid electrolyte, and an argyrodite solid electrolyte, but are not limited to them. Specific examples of the sulfide solid electrolyte include Li₂S—P₂S₅ (Li₇P₃S₁₁, Li₃PS₄, Li₈P₂S₉, or the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, or the like), LiI—Li₂S—P₂O₅, LiI—Li₃PO₄—P₂S₅, Li₇₋ₓPS₆₋ₓClₓ, and a combination of them, but are not limited to them.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ(LiPON), but are not limited to them.

The sulfide solid electrolyte and the oxide solid electrolyte may be glass, or may be crystallized glass (glass ceramics).

Examples of the polymer electrolyte include polyethylene oxide (PEO), polypropylene oxide (PPO), and a copolymer of polyethylene oxide and polypropylene oxide, but are not limited to them.

### Dispersion Medium

The dispersion medium is not particularly limited. Examples of the dispersion medium include tetralin (1,2,3,4-tetrahydronaphtalene), anisole, xylene, octane, hexane, decalin, butyl acetate, ethyl propionate, tripropylamine, N-methyl-2-pyrolidone (NMP), and water, but are not limited to them. Although not particularly limited, as the dispersion medium, only one kind may be used alone, or two or more kinds may be combined and used.

### Binder

Although not particularly limited, as the binder, a rubber binder, polyvinylidene fluoride (PVdF), polytetrafluoroethylene (PTFE), polyacrylic acid (PAA), or the like can be used. Examples of the rubber binder include butadiene rubber (BR) and styrene-butadiene rubber (SBR), but are not limited to them. Although not particularly limited, as the binder, only one kind may be used alone, or two or more kinds may be combined and used. Although not particularly limited, it is preferable that the electrode composite material slurry for the solid battery in the present disclosure contains the rubber binder.

### Conduction Aid

The conduction aid is not particularly limited. Examples of the conduction aid include vapor-grown carbon fiber (VGCF), acetylene black (AB), Ketjen black (KB), carbon nanotube (CNT), and carbon nanofiber (CNF), but are not limited to them. The conduction aid may have a particle form or a fiber form, for example, and the size of the particle or fiber is not particularly limited. Although not particularly limited, as the conduction aid, only one kind may be used, or two or more kinds may be combined and used.

### Particle Diameter of Electrode Composite Material Slurry

The particle diameter of the electrode composite material slurry for the solid-state battery in the present disclosure that is measured by the fineness gauge method is 60 μm or less.

The particle diameter of the electrode composite material slurry that is measured by the fineness gauge method can be evaluated in accordance with JIS K 5600-2-5 (1999). Specifically, the electrode composite material slurry is dropped onto a fineness gauge table, and is extended by a scraper so as to become thin in a gauge groove. A point where a conspicuous spot starts to appear on a gauge is observed, and the particle diameter is evaluated. Accordingly, the particle diameter that is measured by the fineness gauge method corresponds to the maximum particle diameter. The particle diameter of the electrode composite material slurry that is measured by the particle gauge method may be 50 μm or less, 45 μm or less, or 40 μm or less, and may be 1 μm or more, 5 μm or more, 10 μm or more, 15 μm or more, or 20 μm or more.

### Production Method for Electrode Composite Material Slurry

The electrode composite material slurry for the solid-state battery in the present disclosure can be produced by the following steps:
providing a preliminary electrode composite material slurry that contains an electrode active material, a solid electrolyte, and a dispersion medium; and
(i) preparing the electrode composite material slurry by applying a dispersion energy of 1.0×10⁶ J/L or more to the preliminary electrode composite material slurry and stirring the preliminary electrode composite material slurry and/or (ii) preparing the electrode composite material slurry by stirring the preliminary electrode composite material slurry until the particle diameter that is measured by the fineness gauge method becomes 0.75 times or less the particle diameter that is measured by the fineness gauge method when a dispersion energy of 5.0×10⁵ J/L is applied to the preliminary electrode composite material slurry and the preliminary electrode composite material slurry is stirred.

With the production method for the electrode composite material slurry for the solid-state battery in the present disclosure, it is possible to obtain an electrode composite material slurry that forms the electrode active material layer that reduces the battery resistance.

The inventors have studied the dispersion energy when the electrode composite material slurry is prepared, and have found that an electrode active material layer with a reduced resistance can be obtained by the use of an electrode composite material slurry for which a dispersion energy of 1.0×10⁶ J/L or more is applied to the preliminary electrode composite material slurry.

Further, the preliminary electrode composite material slurry is not uniform immediately after the dispersion energy is applied, and therefore, it is difficult to measure the particle diameter by the fineness gauge method. However, when a dispersion energy of 5.0×10⁵ J/L is applied to the preliminary electrode composite material slurry and stirring is performed, the non-uniformity of the preliminary electrode composite material slurry is resolved, so that the particle diameter can be easily measured by the fineness gauge method. Moreover, it has been found that the electrode active material layer with a reduced resistance can be obtained also by the use of an electrode composite material slurry for which the dispersion energy is applied until the particle diameter becomes 0.75 times or less the particle diameter that is measured by the fineness gauge method when a dispersion energy of 5.0×10⁵ J/L is applied to the preliminary electrode composite material slurry and the preliminary electrode composite material slurry is stirred.

### Provision of Preliminary Electrode Composite Material Slurry

The preliminary electrode composite material slurry in the present disclosure contains an electrode active material, a solid electrolyte, and dispersion medium.

As for the electrode active material, the solid electrolyte, and the dispersion medium that are contained in the preliminary electrode composite material slurry, the above description in “Constitution of Electrode Composite Material Slurry for Solid-State Battery” can be referred to. The preliminary electrode composite material slurry is a precursor of the electrode composite material slurry, and the particle diameter of the preliminary electrode composite material slurry that is measured by the fineness gauge method is not particularly limited.

As the preliminary electrode composite material slurry, a slurry produced by mixing the electrode active material, the solid electrolyte, and the dispersion medium may be used, or a slurry in which the electrode active material, the solid electrolyte, and the dispersion medium are mixed may be got and used.

### Application of Dispersion Energy

The production method for the electrode composite material slurry for the solid-state battery in the present disclosure may include
(i) preparing the electrode composite material slurry by applying a dispersion energy of 1.0×10⁶ J/L or more to the preliminary electrode composite material slurry and stirring the preliminary electrode composite material slurry and/or
(ii) preparing the electrode composite material slurry by stirring the preliminary electrode composite material slurry until the particle diameter that is measured by the fineness gauge method becomes 0.75 times or less the particle diameter that is measured by the fineness gauge method when a dispersion energy of 5.0×10⁵ J/L is applied to the preliminary electrode composite material slurry and the preliminary electrode composite material slurry is stirred.

### Dispersion Energy

The dispersion energy can be applied using an ultrasonic homogenizer (US600AT manufactured by Nippon Seiki Co., Ltd.), for example, but the present disclosure is not limited to this. The dispersion energy can be calculated from the output power and time when the dispersion energy is applied. Although not particularly limited, in the case of the use of the ultrasonic homogenizer (US600AT manufactured by Nippon Seiki Co., Ltd.), the output power that is applied to the preliminary electrode composite material slurry may be 150 W or more, 200 W or more, or 250 W or more, and may be 650 W or less, 600 W or less, or 550 W or less.

The dispersion energy that is applied to the preliminary electrode composite material slurry may be 1.5×10⁶ J/L or more, 2.0×10⁶ J/L or more, or 2.5×10⁶ J/L or more, and may be 1.0×10⁸ J/L or less, 1.0×10⁷ J/L or less, 8.0×10⁶ J/L or less, or 6.0×10⁶ J/L or less.

The method for the stirring is not particularly limited, and a general method for stirring the electrode composite material slurry can be used.

### Others

The electrode active material layer can be produced by a known method, using the electrode composite material slurry in the present disclosure. For example, an electrode composite material slurry containing various components is applied to a base material, and is dried, so that the electrode active material layer can be formed.

The method for forming the solid-state battery is not particularly limited, and a known method can be employed. The solid battery can be formed, for example, by disposing a positive electrode current collector layer, a positive electrode active material layer, a solid electrolyte layer, a negative electrode active material layer, a negative electrode current collector layer, a negative electrode active material layer, a solid electrolyte layer, a positive electrode active material layer, and a positive electrode current collector layer, in this order, and enclosing the respective layers by a laminate film, but the method for forming the solid-state battery is not limited to this. Although not particularly limited, the solid-state battery may be confined, for example, at an external pressure of 5 MPa.

It can be determined that the particle diameter of the electrode composite material slurry used for forming the solid-state battery, which is the particle diameter measured by the fineness gauge method, is 60 μm or less, by observing an SEM image of a cross section of the electrode active material layer of the solid-state battery. As described above, the particle diameter measured by the grind gauge method corresponds to the maximum particle diameter contained in the electrode mixture slurry. Therefore, when the maximum particle diameter observed on the SEM image is 60 μm or less, the particle diameter measured by the grind gauge method can be determined that the particle diameter is 60 μm or less.

The present disclosure will be described in more detail with reference to the following examples. The scope of the present disclosure is not limited to the examples.

### Example 1

### Preparation of Negative Electrode Composite Material Slurry A1

Li₄Ti₅O₁₂ particles as a negative electrode active material, Li₂S—P₂S₅ glass ceramics as a solid electrolyte, a styrene-butadiene rubber (SBR) binder as a binder, conductive carbon as a conduction aid, a dispersion agent, and tetralin as a moderate amount of dispersion medium were mixed, a dispersion energy of 1.0×10⁶ J/L was applied by the ultrasonic homogenizer (US600AT manufactured by Nippon Seiki Co., Ltd.), and stirring was performed, so that a negative electrode composite material slurry A1 was obtained. The dispersion energy was calculated from the output power and time of the ultrasonic homogenizer. The particle diameter of the negative electrode composite material slurry A1 that was measured by the fineness gauge method was 60 μm.

### Production of Negative Electrode Active Material Layer B1

Both surfaces of an aluminum foil as a negative electrode current collector were coated with the negative electrode composite material slurry A1 by die coating, and was dried, so that negative electrode active material layers B1 were produced on both surfaces of the aluminum foil. The negative electrode active material layer B1 had a uniform external appearance with no streaks and no unevenness. The base weight of the negative electrode active material layer was adjusted such that the charge capacity of the negative electrode active material layer was one time the charge specific capacity of the positive electrode active material contained in the positive electrode active material layer when the charge specific capacity of the positive electrode active material contained in the positive electrode active material layer was 200 mAh/g.

### Production of Solid Electrolyte Layer C1

LiI—Li₂S—P₂S₅ glass ceramics as a solid electrolyte, a SBR binder as a binder, conductive carbon as a conduction aid, a dispersion agent, and tetralin as a moderate amount of dispersion medium were mixed, and a dispersion process was performed by the ultrasonic homogenizer (US600AT manufactured by Nippon Seiki Co., Ltd.), so that a solid electrolyte composite material slurry was obtained. Next, an aluminum foil was coated with the solid electrolyte composite material slurry by die coating, and was dried, so that a solid electrolyte layer C1 was produced on the aluminum foil.

### Production of Positive Electrode Active Material Layer D1

LiNi_{0.8}(CoAl)_{0.2}O₂ coated with a Li—Ti—Al—F material as a positive electrode active material, Li₂S—P₂S₅ glass ceramics as a solid electrolyte, a SBR binder as a binder, conductive carbon as a conduction aid, a dispersion agent, and tetralin as a moderate amount of dispersion medium were mixed, and a dispersion process was performed by the ultrasonic homogenizer (US600AT manufactured by Nippon Seiki Co., Ltd.), so that a positive electrode composite material slurry was obtained. Next, an aluminum foil was coated with the positive electrode composite material slurry by die coating, and was dried, so that a positive electrode active material layer D1 was produced on the aluminum foil.

### Production of All-Solid-State Battery E1

Solid electrolyte layers C1 were overlapped and pressed on respective surfaces of the negative electrode active material layers B1 formed on both surfaces of the aluminum foil, and thereby, the solid electrolyte layers C1 were transferred to the surfaces of the negative electrode active material layers B1. Then, the aluminum foils contacting with the solid electrolyte layers C1 were removed, so that the solid electrolyte layers C1 were laminated on the negative electrode active material layers B1. Next, positive electrode active material layers D1 were overlapped and pressed on respective surfaces of the solid electrolyte layers C1 formed on both surfaces of the negative electrode active material layers B1, and thereby, the positive electrode active material layers D1 were transferred to the surfaces of the solid electrolyte layers C1. Then, the aluminum foils contacting with the positive electrode active material layers D1 were removed, so that the positive electrode active material layers D1 were laminated on the solid electrolyte layers C1. Roll press was performed to the produced laminated body at 175° C. at 5 ton/cm, so that a densified laminated body was obtained. Thereafter, carbon-coated aluminum foils as positive electrode current collectors were disposed on respective surfaces of the positive electrode active material layers of the densified laminated body and were pressed at 140° C. at 5 MPa for 5 minutes, so that an electricity generating element was obtained. In the electricity generating element, the carbon-coated aluminum foil, the positive electrode active material layer D1, the solid electrolyte layer C1, the negative electrode active material layer B1, the aluminum foil, the negative electrode active material layer B1, the solid electrolyte layer C1, the positive electrode active material layer D1, the carbon-coated aluminum foil were laminated in this order. The obtained electricity generating element was enclosed by a laminate film, and was confined at 5 MPa, so that an all-solid-state battery E1 was obtained.

### Resistance Measurement of All-Solid-State Battery E1

The constant-current charge of the all-solid-state battery E1 was performed at about 0.3 C until the voltage reached a voltage equivalent to a charge level of 50%, and next, the discharge of the all-solid-state battery E1 was performed at an electric current value of 46 C for 2 seconds. The potential difference between the voltage before the discharge and the voltage after 2-second discharge was evaluated, and the battery resistance was calculated by dividing the potential difference by an electric current value of 46 C. The battery resistance of the all-solid-state battery C1 was 5.1Ω.

### Example 2

### Preparation of Negative Electrode Composite Material Slurry A2

The negative electrode composite material slurry was prepared by the same method as Example 1, except that the dispersion energy was 2.5×10⁶ J/L, and a negative electrode composite material slurry A2 was obtained. The particle diameter of the negative electrode composite material slurry A2 that was measured by the fineness gauge method was m.

### Production of Negative Electrode Active Material Layer B2

The negative electrode active material layer was produced by the same method as Example 1, except that the negative electrode composite material slurry A2 was used, and a negative electrode active material layer B2 was obtained. The negative electrode active material layer B2 had a uniform external appearance with no streaks and no unevenness.

### Production of All-Solid-State Battery E2, and Resistance Measurement

The all-solid-state battery was produced by the same method as Example 1, except that the negative electrode active material layer B2 was used, and an all-solid-state battery E2 was obtained. The battery resistance of the all-solid-state battery E2 was calculated by the same method as the all-solid-state battery E1. The battery resistance of the all-solid-state battery E2 was 5.0Ω.

### Comparative Example 1

### Preparation of Negative Electrode Composite Material Slurry a1

The negative electrode composite material slurry was prepared by the same method as Example 1, except that the dispersion energy was not applied, that is, the dispersion energy was 0 J/L, and a negative electrode composite material slurry a1 was obtained. The particle diameter of the negative electrode composite material slurry a1 that was measured by the fineness gauge method was 100 μm or more.

### Production of Negative Electrode Active Material Layer b1

The negative electrode active material layer was produced by the same method as Example 1, except that the negative electrode composite material slurry a1 was used, and a negative electrode active material layer b1 was obtained. The negative electrode active material layer b1 had a non-uniform external appearance with streaks and unevenness.

### Production of All-Solid-State Battery e1

The negative electrode active material layer b1 had a lot of streaks and unevenness, and therefore, an all-solid-state battery e1 could not be produced.

### Comparative Example 2

### Preparation of Negative Electrode Composite Material Slurry a2

The negative electrode composite material slurry was prepared by the same method as Example 1, except that the dispersion energy was 5.0×10⁵ J/L, and a negative electrode composite material slurry a2 was obtained. The particle diameter of the negative electrode composite material slurry a2 that was measured by the fineness gauge method was 80 μm.

### Production of Negative Electrode Active Material Layer b2

The negative electrode active material layer was produced by the same method as Example 1, except that the negative electrode composite material slurry a2 was used, and a negative electrode active material layer b2 was obtained. The negative electrode active material layer b2 had a uniform external appearance with no streaks and no unevenness.

### Production of All-Solid-State Battery e2, and Resistance Measurement

The all-solid-state battery was produced by the same method as Example 1, except that the negative electrode active material layer b2 was used, and an all-solid-state battery e2 was obtained. The battery resistance of the all-solid-state battery e2 was calculated by the same method as the all-solid-state battery C1. The battery resistance of the all-solid-state battery e2 was 5.6Ω.

Table 1 shows results about Examples 1 and 2 and Comparative Examples 1 and 2.

TABLE 1

| | | Comparative | Comparative | | |
|---|---|---|---|---|---|
| | | Example 1 | Example 2 | Example 1 | Example 2 |
| Negative electrode active | | Negative | Negative | Negative | Negative |
| material layer | | electrode | electrode | electrode | electrode |
| | | active | active | active | active |
| | | material layer | material layer | material layer | material layer |
| | | b1 | b2 | B1 | B2 |
| | Negative electrode | Negative | Negative | Negative | Negative |
| | composite material | electrode | electrode | electrode | electrode |
| | slurry | composite | composite | composite | composite |
| | | material | material | material | material |
| | | slurry a1 | slurry a2 | slurry A1 | slurry A2 |
| | Particle diameter | >100 | 80 | 60 | 40 |
| | [μm] | | | | |
| | Dispersion energy | 0 | 5.0 × 10⁵ | 1.0 × 10⁶ | 2.5 × 10⁶ |
| | [J/L] | | | | |
| | Particle diameter | — | 1.00 | 0.75 | 0.50 |
| | relative to particle | | | | |
| | diameter when | | | | |
| | dispersion energy of | | | | |
| | 5.0 × 10⁵ J/L was | | | | |
| | applied | | | | |
| Solid electrolyte layer | | — | Solid | Solid | Solid |
| | | | electrolyte | electrolyte | electrolyte |
| | | | layer C1 | layer C1 | layer C1 |
| Positive electrode active | | — | Positive | Positive | Positive |
| material layer | | | electrode | electrode | electrode |
| | | | active | active | active |
| | | | material layer | material layer | material layer |
| | | | D1 | D1 | D1 |
| All-solid-state battery | | — | All-solid-state | All-solid-state | All-solid-state |
| | | | battery e2 | battery E1 | battery E2 |
| Evaluation | External appearance | Non-uniform | Uniform | Uniform | Uniform |
| | of negative electrode | | | | |
| | active material layer | | | | |
| result | Battery resistance of | — | 5.6 | 5.1 | 5.0 |
| | all-solid-state | | | | |
| | battery [Ω] | | | | |

When the particle diameter measured by the fineness gauge method was 60 μm as in the case of the negative electrode composite material slurry A1 in Example 1, the electrode active material layer having a uniform external appearance could be obtained, and the battery resistance of the all-solid-state battery including the electrode active material layer formed from the negative electrode composite material slurry A1 was sufficiently low. Further, when the particle diameter measured by the fineness gauge method was 80 μm as in the case of the negative electrode composite material slurry a2 in Comparative Example 2, the electrode active material layer having a uniform external appearance could be obtained. However, the battery resistance of the all-solid-state battery e2 including the electrode active material layer formed from the negative electrode composite material slurry a2 was as high as 5.6Ω. It became clear that it is possible to obtain an electrode active material layer that has a uniform electrode active material layer and that reduces the battery resistance when the particle diameter of the electrode composite material slurry that is measured by the fineness gauge method is 60 μm.

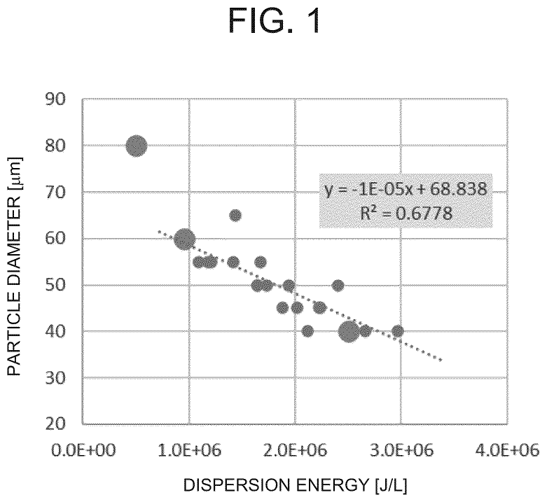

FIG. 1 shows the relation between the dispersion energy and the particle diameter of the electrode composite material slurry that is measured by the fineness gauge method about Examples 1 and 2 and Comparative Example 2. FIG. 1 reveals that the particle diameter that is measured by the fineness gauge method is smaller as the dispersion energy is larger. Particularly, when a dispersion energy of 1.0×10⁶ J/L or more was applied, the particle diameter measured by the fineness gauge method was 60 μm or less. As for the negative electrode composite material slurry A1 in Example 1 for which a dispersion energy of 1.0×10⁶ J/L was applied, the battery resistance of the all-solid-state battery E1 obtained from the negative electrode composite material slurry A1 was sufficiently low. It is thought that the particle diameter of the electrode composite material slurry that was measured by the fineness gauge method became sufficiently small by the application of a dispersion energy of 1.0×10⁶ J/L or more and thereby it was possible to obtain the electrode active material layer that reduced the battery resistance.

Preferred embodiments of the electrode composite material slurry for the solid-state battery and the production method for the electrode composite material slurry in the present disclosure have been described. However, a person skilled in the art understands that modifications can be made without departing from the scope of the claims.

What is claimed is:

1. An electrode composite material slurry for a solid-state battery, wherein:
the electrode composite material slurry contains an electrode active material, a solid electrolyte, and a dispersion medium; and
a particle diameter of the electrode composite material slurry that is measured by a fineness gauge method is 60 μm or less.

2. The electrode composite material slurry according to claim 1, wherein the electrode composite material slurry contains a rubber binder.

3. The electrode composite material slurry according to claim 1, wherein the electrode composite material slurry contains a negative electrode active material.

4. A production method for the electrode composite material slurry according to claim 1, the production method comprising:
providing a preliminary electrode composite material slurry that contains an electrode active material, a solid electrolyte, and a dispersion medium; and
(i) preparing the electrode composite material slurry by applying a dispersion energy of 1.0×10⁶ J/L or more to the preliminary electrode composite material slurry and stirring the preliminary electrode composite material slurry and/or (ii) preparing the electrode composite material slurry by stirring the preliminary electrode composite material slurry until the particle diameter that is measured by the fineness gauge method becomes 0.75 times or less the particle diameter that is measured by the fineness gauge method when a dispersion energy of 5.0×10⁵ J/L is applied to the preliminary electrode composite material slurry and the preliminary electrode composite material slurry is stirred.

5. An electrode active material layer for a solid battery, comprising:
a maximum particle diameter of an electrode active material and a solid electrolyte measured from an SEM image of a cross section of the electrode active material layer is 60 μm or less.
